(19) United States
(12) Patent Application Publication
(10) Pub. No.: US 2020/0262940 A1
(43) Pub. Date: Aug. 20, 2020

(54) Methods of Releasing Glycans from Peptides and Other Conjugates

(71) Applicant: Emory University, Atlanta, GA (US)

(72) Inventors: Xuezheng Song, Decatur, GA (US); Richard Cummings, Boston, MA (US); David Fletcher Smith, Atlanta, GA (US)

(21) Appl. No.: 16/061,313

(22) PCT Filed: Dec. 9, 2016
(86) PCT No.: PCT/US16/65889

§ 371 Date: Jun. 11, 2018

Related U.S. Application Data
(60) Provisional application No. 62/266,510, filed on Dec. 11, 2015.

(51) Int. Cl. C08B 37/00

(52) U.S. Cl. CPC C08B 37/0075

(57) ABSTRACT

This disclosure relates to methods of producing glycans from samples containing glycoconjugates using a salt of a hypohalous acid. Methods for producing N-glycans, O-glycans and lipid linked-glycans are provided. Compositions with novel O-glycans or lipid linked-glycans are provided. Methods of producing glycosaminoglycans from samples, particularly animal tissue samples containing proteoglycans, are provided.

### CROSS REFERENCE TO RELATED APPLICATIONS

This application claims the benefit of U.S. Provisional Application No. 62/266,510 filed Dec. 11, 2015. The entirety of this application is hereby incorporated by reference for all purposes.

### STATEMENT REGARDING FEDERALLY FUNDED RESEARCH

This invention was made with government support under grants GM085448, P41GM10369, and U01GM116254 awarded by the National Institutes of Health. The government has certain rights in the invention.

### BACKGROUND

Glycans are composed of multiple glycosidically linked monosaccharides connected to form linear as well as complex, branched structures. Glycans are hydrophilic molecules that can vary in size from a single monosaccharide to extremely large polysaccharides, and they are typically present on cell surfaces as well as other cellular compartments conjugated to protein and lipid. N-linked or O-linked glycans are found on glycoprotein and proteoglycans, e.g., protein conjugates, and glycans are also coupled to lipids such as ceramide, e.g., glycolipids. Glycomes (the entire complement of sugars, whether free or present in more complex molecules of an organism, organ, tissue or cell) of animals, microorganisms and plants are highly complex. Complete structural elucidation of the glycans in any glycome, has been exceedingly difficult due to the challenges associated with obtaining sufficient quantities of natural material for study. The classical approach to defining a glycome of any source is to analyze the glycans released from a sample by harsh chemical methods or specific enzymes. The released glycans are then processed for analysis and typically observed as unique HPLC, mass spectroscopic or capillary electrophoretic profiles of samples. However, the individual glycans must then be isolated in mg quantities for unequivocal structural definition, which is difficult since there are no automated methods for structural analysis of glycans. Thus, the complete definition of a glycome by this approach is currently not practical.

During their biosynthesis glycans are co-translationally added to proteins and in that process they participate in appropriate folding of the proteins. Glycan functions at cell surfaces, on the other hand, are thought to be related to their interaction with other proteins in intercellular interactions, transmembrane signaling, and routes of infection via adhesins on microorganisms including viruses and bacteria that bind cell surface glycans. Explorations of glycan functions have also been exceedingly difficult due to the challenges associated with obtaining sufficient quantities of natural material for study. One of the most important advances in studies of protein-glycan interactions has been the development of the glycan microarray, whereby all of the glycans released from a glycome are purified, and the individual glycans are stored as libraries for further analysis. One such analysis is to print purified glycans on a microscope slide as a microarray of hundreds of glycans (Song et al., Glycan microarrays of fluorescently-tagged natural glycan, Glycoconj J, 2015) and subsequently expose the array to biologically relevant glycan binding proteins (GBP). GBP bound to glycans on the microarray are detected using fluorescent labels and the protein-glycan interactions are quantified by appropriate instrumentation. Thus, biologically relevant glycans are detected and they can be retrieved from original library and structurally defined. This approach, termed “Shotgun Glycomics”, is used to identify specific protein-glycan interactions and is considered a functional approach to the field of glycomics (Song et al., “Shotgun glycomics: a microarray strategy for functional Glycomics”, Nat Methods, 2011 and Zaia, “At last, functional glycomics”, Nat Methods, 2011).

The major obstacle in Shotgun Glycomics is the process of obtaining sufficient quantities of all of the glycans in a glycome for production of comprehensive glycan libraries. Unlike the recombinant expression of proteins to amplify proteins for structural and functional studies, and the polymerase chain reaction to amplify nucleic acids for structural and functional studies; there is no corresponding technique to amplify biologically relevant glycans. Currently the routes to building glycan libraries are chemical and enzymatic synthesis, but these techniques are limited to generating only previously characterized glycan structures with little information regarding their biological relevance. Another route to building glycan libraries is by isolating the glycans of glycomes from natural sources; however, generating glycan libraries for functional glycomic analyses requires starting with large quantities of organisms, organs, tissues or cells to obtain the glycans, which comprise only a small fraction of wet weight of starting material. All current methods for releasing glycans from their corresponding glycoconjugates are based on either enzymes (N-glycanses, ceramidases etc.) or harsh chemicals (hydrazine, sodium hydroxide, ammonia etc.) where they are practically limited to relatively small amounts of starting material (≤1 to 10 grams).

Reported methods for releasing natural glycans in the form of reducing glycans include ammonium hydroxide and carbonate-based chemical deglycosylation and PNGase A and F enzymatic release. See Huang et al, Anal Chem, 2001, 73, 6063-6069 and Triguero et al, Analytical Biochemistry, 2010, 400, 173-183. These methods have a limited ability to release abundant amounts of all types of glycans from the proteins and lipid that the glycans are naturally associated. Thus, there is a need to identify improved method of releasing glycans. Yuan et al. report a nonreductive chemical release of N-glycans from glycoproteins in mild alkaline medium (Anal Biochem, 2014, 462, 1-9). Song et al. report a strategy to release and tag N-glycans for functional glycomics using an enzymatic threshing and trimming technique. Bioconjug Chem, 2014, 25(10):1881-7.

References cited herein are not an admission of prior art.

### SUMMARY

This disclosure relates to a process involving oxidative release of glycans from glycoconjugates synthesized by living organisms whereby microscale through large quantities of starting material can be used. Application of this process to small quantities of sample (microgram to milligram) permits rapid, non-specific release of glycans that can be processed for analytical purposes, e.g., identifying HPLC, mass spectroscopic or capillary electrophoretic profiles of samples. Application of this process to large quantities of sample (≥1-10 Kg) permits rapid, non-specific release of glycans that can be processed for the large scale production of glycans to overcome the difficulties in obtaining sufficient quantities of natural glycans for study. In certain embodiments, the disclosure relates to compositions made by the process of mixing the source of a glycome, e.g., fungal, bacterial, plant or animal organisms, organs, tissues, cells or lysates thereof or compositions derived therefrom with a salt of hypohalous acid (or an oxidant can be used to generate a salt of hypohalous acid in situ) and separating the glycans from proteins, polypeptides, amino acids, lipids, and other degradation products providing isolated glycans. In certain embodiments, the released glycans are further reacted with an alkyl halide to provide alkylated products for better analysis of glycan structures. The isolated glycans or alkylated products may be further conjugated to detectable tags, purified and used in the generation of glycan arrays that represent the glycome of the starting material.

In certain embodiments, the disclosure relates to methods of producing one or more types of glycans comprising mixing a salt of hypohalous acid with a sample of organisms, organs, tissues, cells or lysates thereof, wherein the sample comprises glycoconjugates, with a low concentration of a salt of a hypohalous acid under conditions such that 1) N-glycans are released from the glycoproteins, 2) O-glycans are released from the glycoproteins, and/or 3) lipid-linked glycans coupled to lipids are released from the glycolipids. In certain embodiments, the released glycans are separated from the non-glycan components of the sample to provide isolated glycans. In certain embodiments, the concentration of the salt of hypohalous acid is between 0.1% and 10%. In embodiments, the disclosure relates to compositions comprising O-glycans released from glycoproteins wherein the O-glycans comprise a carboxylic acid moiety formed by the oxidation of an amino acid in the glycoprotein. In embodiments, the disclosure relates to compositions comprising lipid-linked glycans released from glycolipids wherein the lipid-linked glycans comprise an alkyl nitrile moiety formed by the oxidation of the lipid from the glycolipid. In embodiments, mixtures of one or more of the above compositions further comprise released N-glycans.

In certain embodiments, the tissue sample is from animal cell culture lines, recombinant proteins, antibodies, extracted animal proteins, blood, plasma, saliva, urine, milk, and animal organs. In certain embodiments, the animal is a cow or pig. In certain embodiments, the glycans are released from proteoglycans to produce glycosaminoglycans including crude heparin, heparan sulfate, hyaluronan, chondroitin sulfate, dermatan sulfate, and keratan.

In certain embodiments, the salt of hypohalous acid is sodium hypochlorite, calcium hypochlorite or potassium hypochlorite.

In certain embodiments, the released O-glycans, originally found glycosidically linked to serine or threonine (FIG. 1) or other hydroxylated amino acids in proteins, comprise glycans in their original glycosidic linkage to a carboxylic acid derived from the oxidation of the hydroxylated amino acid residue in the peptide backbone (FIG. 3A).

In certain embodiments, the released lipid-linked glycans originally found in glycolipid glycosidically linked to ceramide (FIG. 1) or other similar structures in glycolipids, comprise glycans in their original glycosidic linkage to a fragment of the lipid having a new nitrile function resulting from the oxidative degradation of the lipid (FIG. 3A).

### BRIEF DESCRIPTION OF THE DRAWINGS

FIG. 1 illustrates the release of natural glycans by sodium hypochlorite (NaClO).

FIG. 2 illustrates the chemical scheme of oxidative release for sodium hypochlorite treatment of glycoproteins to release N-glycans and subsequent labeling.

FIG. 3 illustrates the chemical scheme of oxidative release for sodium hypochlorite treatment of glycoproteins to release O-glycans and subsequent labeling.

FIG. 4 illustrates the chemical scheme for release and tagging of glycans from glycosphingolipids (GSL) by NaClO.

FIG. 5 illustrates nitrous acid degradation and AEAB conjugation to heparin.

FIG. 6 illustrated comparison of MALDI-TOF profile of N-glycans released from samples of by PNGase F digestion (top) or by sodium hypochlorite (NaClO)(bottom).

### DETAILED DESCRIPTION

To promote an understanding of the principles of the present disclosure, descriptions of specific embodiments of the disclosure follow and specific language is used to describe the specific embodiments. It will nevertheless be understood that no limitation of the scope of the disclosure is intended by the use of specific language. Alterations, further modifications, and such further applications of the principles of the present disclosure discussed are contemplated as would normally occur to one ordinarily skilled in the art to which the disclosure pertains.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of medicine, organic chemistry, biochemistry, molecular biology, pharmacology, and the like, which are within the skill of the art. Such techniques are explained fully in the literature.

It must be noted that, as used in the specification and the appended claims, the singular forms “a,” “an,” and “the” include plural referents unless the context clearly dictates otherwise. In this specification and in the claims that follow, reference will be made to a number of terms that shall be defined to have the following meanings unless a contrary intention is apparent.

As used herein a “sample” refers to a composition taken from or originating from a subject. Examples of samples include cell samples, blood samples, tissue samples, hair samples, and urine or excrement samples.

As used herein, the term “tag” is used broadly to encompass a variety of types of molecules which are detectable through spectral properties (e.g., fluorescent markers or “fluorophores” and colored or uv absorbing markers or “chromophores”) or through functional properties (e.g., affinity markers). A representative affinity marker includes biotin, which is a ligand for avidin and streptavidin. An epitope marker is a marker functioning as a binding site for antibody. Since chimeric receptor proteins and antibodies can be produced recombinantly, receptor ligands are effective affinity markers.

As used herein the term “tag” or “tagged” molecule refers to a molecule that will photoluminescence, i.e., emit light as a result of the absorption of photons, e.g., fluorescence or phosphorescence or absorb light and be detected by measuring absorbance at an appropriate wavelength.

By “N-glycans” we mean glycans that are or were attached to protein via a glycosyl amide linkage where the glycan is attached to a nitrogen atom; e.g., the amide nitrogen of asparagine (Asn) residue of a protein. Thus, N-glycan refers to the free, reducing glycan released from protein by N-glycosidases, e.g. Peptide-N-Gycosidases F or A (PNGase F or A), or by chemical processes, e.g., hydrazinolysis or oxidation with salt of hypohalous acid or the glycan in the protein prior to its enzymatic or chemical release.

By “O-glycans” we mean glycans that are or were attached to protein via a glycosidic linkage where the glycan is attached to an oxygen atom in an amino acid residue in a protein. Thus, O-glycan refers to the free, reducing glycan released from protein by O-glycosidases, e.g. Endo-α-N-Acetylgalactosaminidase, or by chemical processes, e.g., hydrazinolysis or base catalyzed elimination or the glycan in O-glycosidic linkage to the protein prior to its enzymatic or chemical release or the glycan in the protein prior to its enzymatic or chemical release. It has been discovered that in applying the methods disclosed herein, the release of O-glycans from protein with a salt of hypohalous acid, results in the glycan being released as a component of the protein degradation products generated by oxidation with a salt of hypohalous acid, not as a free reducing glycan as described above for the methods of release in the art. In the methods disclosed herein, an O-glycan present in the product of the methods is identical to its predecessor glycan in the starting material, but the amino acid to which that O-glycan was originally linked has been altered by the oxidation reaction to a new carboxylic acid derivative. Herein the term O-glycan includes the glycan associated with this novel amino acid derivative.

By “lipid-linked glycans” we mean glycans that are or were attached to lipid, e.g., ceramide, via a glycosidic linkage where the glycan is attached to an oxygen atom in a lipid, e.g., glycosphingolipids. Thus, lipid-linked glycan refers to the free, reducing glycan released from lipid by ceramide glycanases or by chemical processes, e.g., ozonolysis of glycosphingolipids followed by base elimination of the reducing glycan or the glycan in O-glycosidic linkage to the glycolipid prior to its enzymatic or chemical release. It has been discovered that in applying the methods disclosed herein, the release of lipid-linked glycan from glycolipid with a salt of hypohalous acid, results in the glycan being released as a component of a fragment of the original glycolipid generated by oxidation with a salt of hypohalous acid, not as a free reducing glycan as described above for the methods of release in the art. In the methods disclosed herein, the lipid-linked glycan present in the product of the methods is identical to its predecessor glycan in the starting material, but the fragment of the lipid to which it was originally linked has been altered by the oxidation reaction to a novel alkyl nitrile. Herein, the term lipid-linked glycan includes the glycan associated with this novel lipid fragment.

By “aglycone” we mean the compound remaining after the glycosyl group on a glycoside is replaced by a hydrogen atom.

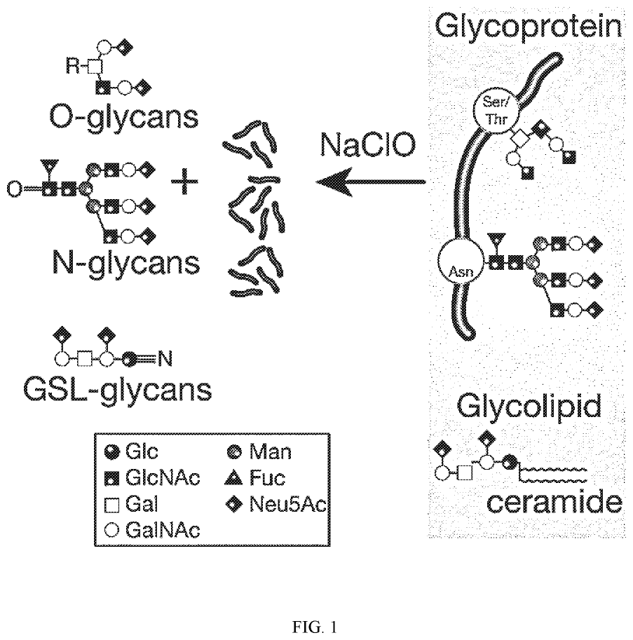

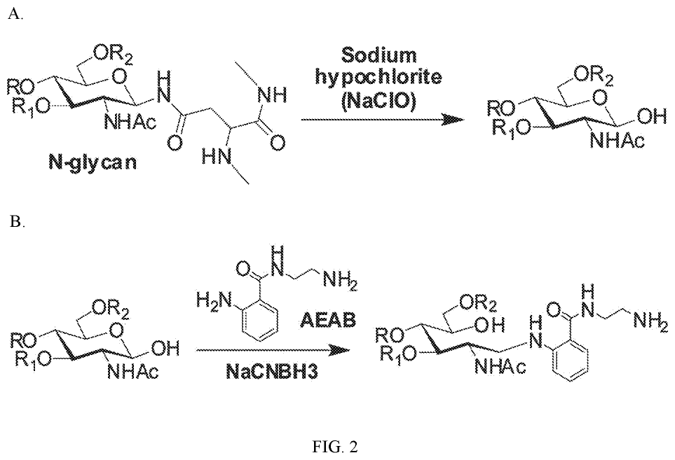

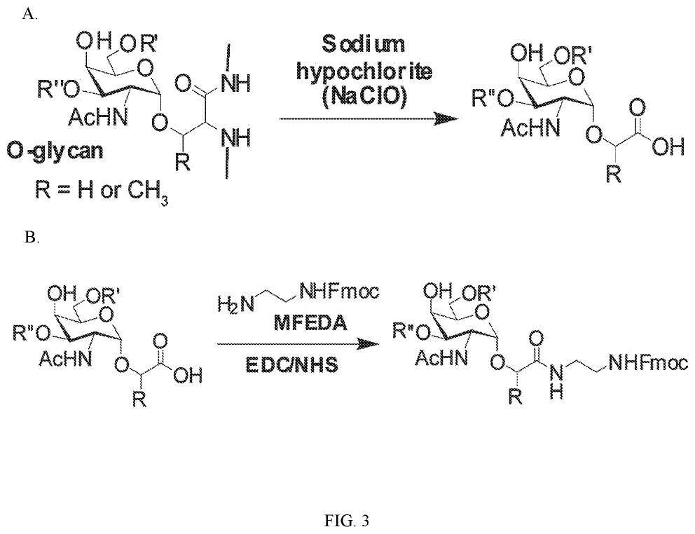

It has been discovered that controlled treatment of biological samples, for example glycoproteins, proteoglycans, and glycosphingolipids (GSLs) with salts of hypohalous acids, a process referred to herein as “Oxidative Release of Natural Glycans” or ORNG, selectively releases intact N-glycans, O-glycans (including glycosaminoglycans) and lipid-linked-glycans (FIG. 1) from natural sources; e.g., microbial, plant, or animal, with minimal processing, thereby providing robust natural glycan repositories and libraries for structural and functional assays. Salts of hypohalous acid, such as sodium hypochlorite (NaClO), effectively degrade the aglycon portion of glycoconjugates leaving glycans, which are highly oxidized as hydrates of carbon, intact (FIG. 2A). It has been discovered that glycans are degraded with NaClO more slowly than peptide backbones, and that naturally occurring modifications of glycans such as O-acetylation, O-sulfation, and O-phosphorylation are also retained.

ORNG is applicable to many glycoproteins, including ovalbumin, immunoglobulins, and horseradish peroxidase (HRP). The release of N-glycans from HRP by the methods disclosed herein demonstrates that the N-glycans of many plant and insect proteins possess core α3-fucose modification of its N-glycans, while this modification on most mammalian systems is an α6-fucose modification. The core α3-fucose modification of N-glycans is resistant to PNGase F digestion. The demonstrated non-specificity of the ORNG process makes its applicability much more widespread than the techniques currently used. Sialylation is also preserved during ORNG, as released glycans from bovine fetuin after permethylation show similar profiles to those released by PNGase F.

N-glycans derived by ORNG retain their free, reducing end and can further be tagged specifically for chromatographic separation, for introducing functional groups for subsequent chemical modification; e.g., covalent attachment to solid phases or addition of other tags, and structural elucidation.

Tagged N-glycans are purified and printed on microscope slides to generate glycan microarrays that are used in functional glycomic studies. Glycan microarrays are interrogated with physiologically important glycan binding proteins (GBP) to identify biologically relevant protein-glycan interactions. When glycan arrays are interrogated with GBP of know glycan binding specificity; e. g., a collection of many well characterized lectins or glycan-specific antibodies, the binding profiles of each glycan, provide information about specific structures in each glycan aiding in their structural characterization. Thus, ORNG permits the exploitation of ‘shotgun glycomics’ which is an effective method to both identify potential glycan ligands for GBPs and anti-glycan antibodies, as well as sequencing the glycans within the relevant glycomes.

The ORNG methods described herein can be practiced using samples of biological or biologically-derived materials from animals, including humans, plants, insects, fungi and bacteria. Tissue and cell cultures, cloned cell lines, cell lines for recombinant protein production and recombinantly produced proteins derived therefrom, antibodies, including immunoglobin preparations and monoclonal preparations, extracted animal proteins, blood, plasma, saliva, urine, milk, and human and animal organs, for example mouse gastrointestinal tract segments.

For large scale preparation of glycans, materials collected from livestock animals are useful, such as pig, cow, chicken and sheep. Specific organs from animals that are useful include liver, kidney, lung, eggs, egg whites, egg yolks, and expired human plasma.

The ORNG method is applicable to large quantities of glycoproteins, which represents a significant advantage over the use of enzymes for releasing N-glycans. Enzymatic methods not only lack broad specificity of release, they can only be used at a small scale. Other chemical methods used for releasing glycans require harsh reaction conditions that alter the released glycans, are toxic to operators, and are hazardous when used at a large scale, e.g. hydrazine. The ORNG method as applied to large quantities of starting material addresses one of the major problems in glycomics: the lack of methodology to amplify glycans. Using large quantities of starting material is essentially an amplification process relative to the classical methods for glycan release. Increasing the size of a sample by several orders of magnitude results in several orders of magnitude increase in the amount of glycans from any one sample. In large amounts of material produced by ORNG, minor glycans are detectable and available for characterization which cannot be accomplished from samples that are several orders of magnitude smaller. The range of major and minor glycans in a complex tissue sample prepared by ORNG on a large amount of starting material are then analyzed by powerful methods such as NMR.

Treatment of glycoproteins with salts of hypohalous acids releases O-glycans as glycosides of glycolic acid or lactic acid. When the ORNG process is applied to proteins possessing O-glycans, the O-glycosidic linkages are stable, but the peptide bonds are degraded. The oxidative cleavage of the peptide bonds degrades proteins into small fragments, in which serine/threonine residues are eventually oxidized to glycolic/lactic acids, respectively. O-glycans, which are attached to the β-O-position of serine/threonine, are effectively released as O-glycans attached to α-O-position of glycolic/lactic acids. Such compounds as products of this oxidation have not been previously reported.

O-glycans released from proteins by the methods herein are tagged specifically for chromatographic separation, for introducing functional groups for subsequent chemical modification; e.g., covalent attachment to solid phases or addition of other tags, and structural elucidation. Tagged O-glycans are purified and printed on microscope slides to generate glycan microarrays that are used for functional glycomic studies.

In glycolipids (glycosphingolipids) treated with salts of hypohalous acids according to the methods described herein, the O-glycosidic linkage between glycan and lipid moiety is stable, but the amide bond in the lipid moiety is oxidatively transformed to a nitrile group while a large portion of the lipid moiety is removed. The glycans are effectively released from glycosphingolipids as cyanomethyl O-glycoside. Such compounds as products of this oxidation have not been previously reported.

The lipid-linked glycans released from glycolipids by the methods described herein are further tagged specifically for chromatographic separation, for introducing functional groups for subsequent chemical modification; e.g., covalent attachment to solid phases or addition of other tags, and structural elucidation. Tagged lipid-linked glycans are purified and printed on microscope slides to generate glycan microarrays that are used in functional glycomic studies.

Glycans released by the ORNG method are subjected to permethylation and other methods for identifying the structure of the glycans. Glycans with a fluorescent tag are analyzed by HPLC, liquid chromatography-mass spectroscopy (LC-MS), and/or capillary electrophoresis to identify profiles of glycans separated on the basis of size, charge, and conformation. When processing a complex tissue as the starting material, these glycan profiles represent “fingerprints” for the starting material.

The method of ORNG described herein can be directly applied to whole plant or animal tissues including liver, lung, kidney, intestine, etc. to release N-glycan, O-glycan and lipid-linked glycans.

The amount of a salt of a hypohalous acid used in applications of the ORNG methods described herein is determined by the composition being treated. For purified and partially purified preparations of glycoproteins and glycolipids, amounts of a salt of a hypohalous acid are added to bring the concentration in the preparation to between approximately 0.1% and 2% (w/v) and the amount of hypohalous salt is calculated based on an equimolar of hypohalous salt compared to estimated amount of total amino acid residues. For organs and other complex tissues from animals, samples are first homogenized in an aqueous solvent, for example water, and sufficient salt of a hypohalous acid is added to bring the concentration to between approximately 0.5% and 3% (v/v) and the amount of hypohalous salt is calculated based on an equimolar of hypohalous salt compared to estimated amount of total amino acid residues. It is understood that small variations in the amounts of the salt of a hypohalous acid to a particular sample can be made in connection with the time of exposure of the sample to the salt in order to accomplish the methods disclosed herein.

N-glycans, O-glycans and lipid-linked glycans, released by salts of hypohalous acids from glycoproteins and glycolipids, possess different chemical structures at their reducing ends. N-glycans possess a hemiacetal (free, reducing end) that can react as an aldehyde (FIG. 2A). The hemiacetal can be conjugated with compounds containing amine through reductive amination (FIG. 2B). O-glycans possess a hydroxylated carboxylic acid as an aglycone attached at the reducing end through an O-glycosidic linkage. The carboxylic acid can be conjugated with compounds containing an amine function through amidation. Lipid-linked glycans possess a cyanomethyl group attached at the reducing end through an O-glycosidic linkage. The cyano or nitrile functional group can be reduced to a primary amine and further conjugated with compounds containing carboxylic acid or activated carboxylic acid. Therefore, tags can be designed that could specifically conjugate N-glycans, O-glycans and lipid-linked glycans released by salts of hypohalous acids from complex samples containing all glycoconjugates to facilitate the isolation the individual classes of glycans.

The salts of hypohalous acids can be household bleach, bleach powder and hypohalous salts generated in situ by mixing a halogen oxidant such as chlorine gas with bases such as sodium hydroxide.

The method of ORNG described herein can be applied effectively to produce large quantities of an important drug in modern medicine, heparin, which is widely used as an anti-coagulation agent. Heparin is a glycosamnioglycan (GAG) that is synthesized in animals as a proteoglycan (a protein with covalently attached GAG) and stored in mast cells. When mast cells are immunologically activated, they undergo degranulation and the proteoglycan that is degraded to peptidoglycan and heparin.

As used herein, “crude heparin” refers to an unrefined mixture of heterogeneous linear polysaccharides mainly composed of repeating units of highly sulfated disaccharides containing an uronic acid, either D-glucuronic acid (GlcA) or L-iduronic acid, and D-glucosamine (GlcN), and including various impurities extracted from mammalian tissues. Animal derived heparin is a polysaccharide comprised of variable amounts of a disaccharide-repeating unit of N-acetylglucosamine (GlcNAc) and glucuronic acid (GlcA), which is modified during biosynthesis by addition of sulfate to free hydroxyl group, de-N-acetylation of GlcNAc residues followed by addition of sulfate to the resulting free amino groups, and epimerization of some GlcA residues to iduronic acid (IdoA). The variation in the sequence of the modified polysaccharide, its length and the variation in degree of sulfation result in a heterogeneous population of molecules that are collectively referred to as heparin.

Crude heparin is typically extracted from animal tissue, and commercial preparation of this material involves three basic steps: (1) initial preparation of the animal tissue, usually at the slaughterhouse; (2) separation of heparin from the tissue, using hydrolysis at alkaline pH and proteolytic enzymes (e.g. Charles and Scott J. Biol. Chem. 1933, 102:425-429; U.S. Pat. Nos. 2,571,679, 2,587,924, 2,884,358, and 2,954,321); and (3) recovery of raw heparin, typically taking advantage of the fact that heparin is a highly negatively charged GAG which can be selectively adsorbed to an anion exchange resin. The resin-heparin complex is delivered to a manufacturing facility where the complex is washed and the heparin is subsequently eluted, creating a concentrated heparin solution that is then filtered, precipitated and vacuum dried and is referred to as “stage 12” or “crude” heparin. Such “crude” heparin is supplied to pharmaceutical manufacturers for subsequent purification and refinement to a pharmaceutical-grade product.

The ORNG method described herein can be advantageously applied for the extraction of heparin from animal tissues, for example from pig and cow. The use of hypohalous acid salts provides an immediate decontamination step for the animal tissue, which is an important consideration when using raw animal tissue. The heparin is removed from the treated tissue homogenate by techniques known in the art, such as anion exchange resins. A second product from this method is the mixture of N-glycans, O-glycans, and glycans from glycolipids which are not retained by the anion exchange resin.

Similarly, the procedures disclosed herein are applicable to the extraction of other polysaccharides from animal tissues, such as hyaluronic acid, chondroitin sulfate and keratan sulfate.

### EXAMPLES

### Example 1

To release N-glycans from glycoproteins, glycoproteins (1-10 g) were dissolved in water to 20 mg/mL. To this solution, 0.2 volume of 6% NaClO was added under stirring. After 15 minutes at room temperature, 0.01 volume of formic acid was added to the reaction mixture slowly, stirred for another 5 minutes, and centrifuged to remove insoluble material. The glycoprotein was degraded as evidenced by the increased mobility of carbohydrate positive material during thin layer chromatography (TLC) on silica 60 plates when compared to untreated ovalbumin which remained at the origin. The solvent used to develop the TLC plate is a mixture of isopropanol:acetic acid:water=3:3:2 (v/v/v). The supernatant was dried on a rotary evaporator and the residue was suspended in water and centrifuged to remove insoluble material. The supernatant was desalted over a Sephadex G-25 column (1.6×60 cm), and the desalted solution was passed through a C18 Sep-Pak column (2-10 g resin). The flow through solution was dried and contained released N-glycans as free reducing glycans.

### Example 2

To release N-glycans from egg yolk, egg white, and other animal tissues, the tissues were homogenized with ice cold water using a Waring blender so that the final protein concentration was ˜20 mg/mL based on average protein content estimation. For example, 18 egg yolks (345 g) were mixed with 2,400 mL water in a mechanical stirrer. 6% NaClO (550 mL) was added and the mixture was stirred. NaClO was quickly consumed along with a quick drop of pH from 12 to 9 within 5 minutes. The mixture was stirred for 15 minutes under room temperature. Octanol (3 mL) and formic acid (30 mL) were added slowly and the mixture was stirred for 5 minutes. The mixture was centrifuged at 9,500×g for 30 minutes. The supernatant was collected and dried on rotary evaporator. The residue was resuspended in 200 mL water, filtered and dialyzed in MWCO 1,000 dialysis tubes for 4 hours against running water. The dialysate was made to 1,100 mL by addition of water and pH was adjusted to 9 by addition of 50% sodium hydroxide solution. To this mixture, 46 mL 6% NaClO was added slowly over 10 minutes and the solution stirred for another 2 minutes. Formic acid (10 mL) was added and the mixture was again dried on rotary evaporator. The residue was dissolved in 100 mL water and filtered through 0.45 μm membrane. The filtrate was desalted with a Sephadex G25 column (5×100 cm). Fractions positive with phenol-sulfuric acid assay were collected and lyophilized to give 4.7 g crude glycans. For solid animal tissue/organ, a 20% protein concentration was used for calculation.

### Example 3

Glycans are degraded with NaClO more slowly than peptide backbones. A pure free reducing glycan lacto-N-neotetraose (LNnT) was treated with 1% NaClO. Slight degradation was observed after a treatment of 15 minutes. The major degradation product, through permethylation and MS analysis, was shown to be the sugar lactone/acid derivative with the reducing end oxidized.

### Example 4

Porcine stomach mucin (10 g dry weight) was dissolved/suspended in 500 mL water. To this, 250 mL of 6% NaClO was added under stirring. After 30 minutes at room temperature, formic acid (7.5 mL) was added to the reaction mixture slowly. The mixture was stirred for another 5 minutes, and centrifuged to remove insoluble material. The supernatant was dried on a rotary evaporator and the residue was suspended in water and filtered through 0.45 μm membrane. The filtrate was made to 500 mL by addition of water and adjusted to pH 7.6 by addition of NaOH. To this mixture, 16.6 mL 6% NaClO was added and the mixture was stirred for 24 hours at room temperature. Formic acid (2 mL) was added and the mixture was dried on rotary evaporator. The residue was dissolved in 100 mL water and desalted with a Sephadex G25 column (5×100 cm). Fractions positive for hexose using the phenol-sulfuric acid assay were collected and lyophilized to give 4.3 g crude glycans.

Treatment of bovine submaxillary mucin (BSM) with the ORNG method was carried similarly. Analysis of the glycans by MALDITOF MS revealed the presence of 9-OAc group of the sialic acids. The 9-OAc, which is labile under classical β-elimination methods, was retained using ORNG.

### Example 5

O-glycan-glycolic/lactic acids were dissolved in 0.5 M MES buffer (pH 5.5) to 25 mg/mL. An equal volume of freshly prepared N-hydroxysuccinimide (NETS) (100 mg/mL in DMSO) and an equal volume of EDC (100 mg/mL in DMSO) solutions were added. The mixtures were stirred at room temperature for 15 minutes. An equal volume of MonoFmoc-ethylenediamine (50 mg/mL in DMSO) was added followed by sodium bicarbonate (100 mg/mL of total volume). The mixture was stirred for 1 hour and centrifuged. The supernatant was precipitated into 10 volumes of acetonitrile at −20° C. for one hour. After centrifugation, the pellet was collected and redissolved in water for HPLC purification to generate the tagged O-glycans.

### Example 6

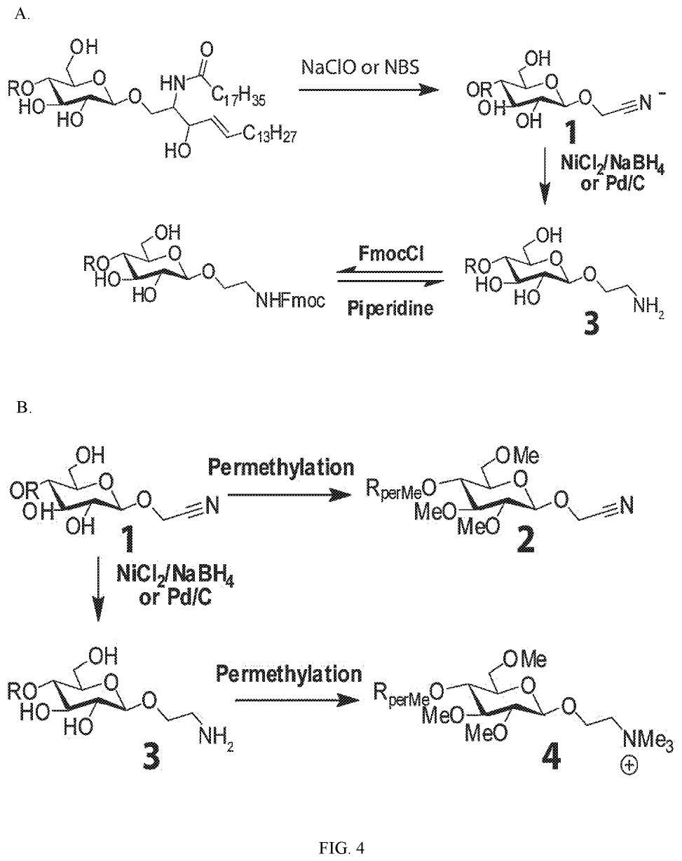

Unmodified porcine brain gangliosides (PBG) containing the common ceramide lipid moiety were treated with NaClO in aqueous conditions. The products were analyzed by MS indicating the loss of the lipid moiety. The major products included a 39 Da molecular mass increase over corresponding free reducing glycans. Based on the structures of GSLs and the oxidative nature of NaClO, the products were deduced to be cyanomethyl glycosides (FIG. 4), which is consistent with the 39 Da mass increase. This reaction can be used to directly treat porcine brain tissue in aqueous conditions, avoiding the organic solvent extraction. Porcine brain (220 g wet weight), which was obtained from a local farmer's market as frozen blocks, was diced into small cubes blended with 440 mL cold water to a homogeneous mixture. To this suspension, 1,320 mL of 6% NaClO was added under vigorous stirring. After 30 minutes, octanol (10 mL) and formic acid (30 mL) was added. The mixture was stirred briefly and stored at 4° C. overnight. The mixture was centrifuged to remove the upper, fatty layer. The residual aqueous material was dried in a rotary evaporator. The residue was dissolved in 100 mL water and desalted on a Sephadex G25 column (5×100 cm). Fractions positive for hexose using the phenol-sulfuric acid assay were collected and lyophilized to give 2.5 g crude GSL-derived glycans.

### Example 7

Crude porcine brain ganglioside nitriles (1.6 g) prepared by ORNG were mixed with 10 g of ammonium formate, 100 mL water and 100 mL methanol. To this solution, 500 mg Pd/C was added and the mixture was stirred at room temperature for 48 hours. The mixture was filtered and the filtrate was dried on rotary evaporator. The residue was desalted on Sephadex G25 column and lyophilized to give 1.3 g crude gangliosides-amines.

The ganglioside-amines were dissolved in 4 mL saturated sodium bicarbonate and 16 mL DMSO. Then 2.6 g Fmoc-OSu was added and the mixture was mixed at 37° C. After 30 minutes, 400 mg sodium bicarbonate and 1.3 g Fmoc-OSu were added and the mixture was mixed for another 30 minutes at 37° C. The mixture was centrifuged and the supernatant was precipitated into 200 mL acetonitrile at 4° C. overnight. The pellet was dried and redissolved in water for HPLC separation to obtain tagged lipid-linked glycans.

### Example 8

In a typical procedure, desalted glycan-nitriles released from GSLs were mixed with 2-AB (25 mM) and ammonium formate (0.5-1M) in 9:1 (water: methanol). Then Palladium (10% on Carbon (Pd/C)) was added (1-2 mg/mL). The mixture was rotated at room temperature for 4 hours and more decolorizing carbon was added to absorb the glycans. The mixture was filtered, washed, and fluorescent tagged lipid-linked glycans were eluted from carbon by 50% acetonitrile with 0.1% TFA.

### Example 9

For small scale glycan analysis and profiling, glycoprotein (50 μL, 10 mg/mL) was mixed with 50 μL saturated borax solution. 100 μL 1% NaClO was added and the mixture was shaken for 1 minute. Formic acid (10 μL) was added to quench the reaction. After briefly cooling on ice (2 minutes), the mixture was centrifuged at 10,000 g for 2 minutes and the supernatant was transferred into a suspension of 5 mg 10% Palladium on C (Pd/C) in 200 μL water in a centrifuge filter with 0.2 μm Nylon membrane. After shaking for 5 minutes at room temperature, the mixture was filtered by centrifugation and the filtrate was discarded. The Pd/C powder was washed with 3×250 μL 1% formic acid. To the Pd/C powder, 100 μL 0.1% formic acid was added and the mixture shaken at 37° C. for 1 hour and centrifuged to remove the filtrate. The Pd/C powder was washed with 250 μL 0.1% trifluoroacetic acid. Glycans were eluted with 50 μL acetonitrile/0.1% trifluoroacetic acid and analyzed by MALDI directly. The eluate was dried and permethylated for MALDI analysis.

In a typical analysis for N-glycans in human plasma a 50 mg/mL protein concentration was assumed. 10 μL of human plasma was mixed with 40 μL water and 50 μL saturated borax solution. 100 μL 1% NaClO was added and the mixture was shaken for 1 minute. Formic acid (10 μL) was added to quench the reaction. After briefly cooling down on ice (2 minutes), the mixture was centrifuged at 10,000×g for 2 minutes and the supernatant was transferred into a suspension of 5 mg 10% Palladium on C (Pd/C) in 200 μL water in a centrifuge filter with 0.2 μm Nylon membrane. After shaking for 5 minutes under room temperature, the mixture was filtered by centrifugation and the filtrate was discarded. The Pd/C powder was washed with 3×250 μL 1% formic acid. To the Pd/C powder, 100 μL 0.1% formic acid was added and the mixture shaken at 37° C. for 1 hour and centrifuged to remove the filtrate. The Pd/C powder was washed with 250 μL 0.1% trifluoroacetic acid. Glycans were eluted with 50 μL acetonitrile/0.1% trifluoroacetic acid and analyzed by MALDI directly. The eluate was dried and permethylated for MALDI analysis.

The MALDI-MS profiles of permethylated glycans from human plasma, released either by ORNG or by PNGase F were very similar, and showed similar contents of multi-sialylated glycans. FIG. 6 shows the MALDI-TOF-MS profiles of permethylated glycans released from normal human plasma by a) PNGase F digestion and b) sodium hypochlorite (bleach) treatment. Several fucosylated glycans, presumably from serum IgG, were shown to be more abundant in the ORNG-released glycans, probably because some glycans may be somewhat resistant to PNGase F digestion.

### Example 10

Porcine intestine was obtained, also referred to as “pig chitterlings.” The tissue (600 g) was minced and blended with 2 volumes (1.2 L) of ice/water. The homogenate was stirred mechanically while adding an equal volume of 6% bleach and stirring was continued for 15 min. A significant amount of lipid floated to the top of the mixture and this was removed manually. Formic acid was added (12 ml) to stop the oxidation and drop the pH from 7.2 to 3.2. After standing overnight at 4° C., the preparation was centrifuged and the supernatant was filtered to remove particulates. An anion exchange resin (Dowex 50-X1 resin) was added (60 g) and the mixture was stirred overnight.

The exchange resin was collected by filtration and washed three times with 100 mL of 2% NaCl solution, and the bound heparin was eluted with 100 ml 4M NaCl solution. The elutate was reduced in volume to ˜80 mL and dialyzed against distilled water in a 1,000 Dalton MWCO membrane. The dialyzed preparation was dried and dissolved into 16 mL water.

### Example 11

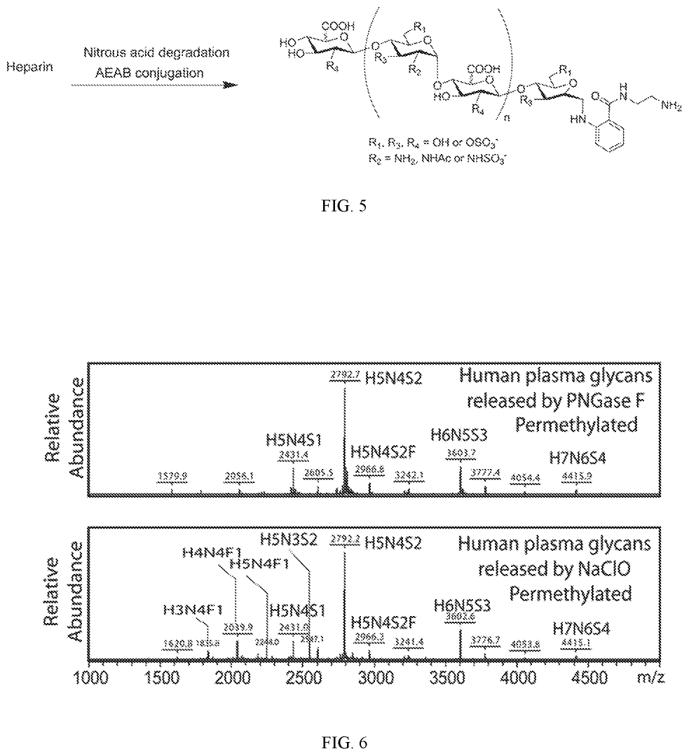

To determine the quality and content of the heparin made by the method disclosed herein, a comparison of the “crude” heparin made by this method and a commercially obtained “crude” heparin was done, by examining oligosaccharide fragments produced through a nitrous acid cleavage of each of these preparations. The principle of the analysis is as follows: The glycosidic bonds of N-sulfated GlcN residues can be rapidly cleaved with nitrous acid at pH 1.5 at room temperature to yield oligosaccharides, which will vary in size depending on the structure of the heparin. A nitrous acid treatment of a heparin preparation will therefore generate a unique set of oligosaccharides that can be labeled with a fluorescent tag and separated into a profile of oligosaccharides by high performance liquid chromatography (HPLC) to generate a “fingerprint” of the heparin preparation. The fluorescent tag, AEAB, can be used to reductively label the glycan fragments as shown in FIG. 5.

Commercially obtained “crude” heparin was dissolved in water to 10 mg/mL. The crude heparin prepared as described above (from 600 g pig chitterlings) was dissolved into 16 mL. 100 μL of each solution were mixed with 70 μL water, 20 μL 10% TFA and 10 μL 10% NaNO₂ on ice to generate the HONO (nitrous acid) in the reaction. After two hours, 50 μL of each reaction mixture were lyophilized and conjugated with 25 μL AEAB/25 μL NaCNBH₃ solutions. The reaction mixtures were precipitated with 600 μL acetonitrile and the pellets, containing the fluorescent labeled oligosaccharides were dissolved in 100 μL water. Ten μL of each were injected for Reverse Phase Ion Pairing HPLC analysis and the column was monitored following fluorescence at an excitation wavelength of 330 nm. The profiles of the crude heparin and commercial heparin are qualitatively identical and show essentially the same relative amounts of fluorescence for all of the peaks in the HPLC.

1. A method of producing one or more of N-glycans, O-glycans and lipid-linked glycans by treating a sample comprising glycoproteins and/or glycolipids with a low concentration of a salt of a hypohalous acid under conditions sufficient to release N-glycans and O-glycans from the glycoproteins and lipid-linked glycans from the glycolipids.

2. The method of claim 1 further comprising separating the N-glycans, O-glycans, and lipid-linked glycans from the non-glycan components of the sample.

3. The method of claim 1 wherein the salt of a hypohalous acid is selected from the group consisting of sodium hypochlorite, potassium hypochlorite, and calcium hypochlorite.

4. The method of claim 1 wherein the sample is selected from the group consisting of animal cell culture lines, recombinant proteins, antibodies, extracted animal proteins, blood, plasma, saliva, urine, milk, and animal organs.

5. The method of claim 1 wherein the sample is in an aqueous solvent and the low concentration is between 0.1% and 10% (v/v) of the salt of hypohalous acid.

6. A composition comprising O-glycans released from glycoproteins wherein the O-glycans comprise a carboxylic acid moiety formed by the oxidation of an amino acid in the glycoprotein.

7. A composition comprising lipid-linked glycans released from glycolipids wherein the lipid-linked glycans comprise an alkyl nitrile moiety formed by the oxidation of the lipid from the glycolipid.

8. The composition of claim 6 further comprising released N-glycans.

9. The composition of claim 8 further comprising the composition of claim 6.

10. A method of producing glycosaminoglycans by treating a sample comprising proteoglycans with a low concentration of a salt of a hypohalous acid under conditions sufficient to release glycosaminoglycans from the proteoglycan.

11. The method of claim 10 wherein the sample is animal tissue selected from the group consisting of liver, lung, duodenum, and intestinal mucosa.

12. The method of claim 11 wherein the animal tissue is selected from the group consisting of pig and cow.

13. The method of claim 10 wherein the glycosaminoglycans are heparin.

14. The method of claim 10 wherein the salt of a hypohalous acid is selected from the group consisting of sodium hypochlorite, potassium hypochlorite, and calcium hypochlorite.

15. The method of claim 10 further comprising separating the glycoaminoglycans from other glycans and degradation products of the sample using a chromatography step.

16. The method of claim 15 wherein the chromatography step is an ion exchange resin.
